(19) United States
(12) Patent Application Publication
(10) Pub. No.: US 2016/0041812 A1
(43) Pub. Date: Feb. 11, 2016

(54) SORTING PROCESSES AND ARRANGEMENTS FOR ELECTRONIC MESSAGES

(71) Applicants: Peter Albert Kaiser, Edina, MN (US); Michael Edward Joseph Zdarsky, Los Angeles, CA (US)

(72) Inventors: Peter Albert Kaiser, Edina, MN (US); Michael Edward Joseph Zdarsky, Los Angeles, CA (US)

(21) Appl. No.: 14/451,646

(22) Filed: Aug. 5, 2014

(51) Int. Cl. G06F 7/08; G06F 17/30

(52) U.S. Cl. CPC G06F 7/08; G06F 17/30716

(57) ABSTRACT

An apparatus displays an arrangement of electronic data sorted by user preferences. The arrangement includes a plurality of electronic objects arranged in a plurality of rows on a graphical display. Each of the objects includes a sender field, a recipient field, a message field, and a time field. The plurality of rows are arranged in the graphical display such that each of the rows is associated with one of the electronic objects. At least one of the fields associated with each object is displayed in each row, and the rows are at least partially arranged by a frequency of communication between the sender and the recipient.

### FIELD OF THE INVENTION

The present invention relates to arranging electronic messages, and more particularly to sorting or identifying electronic messages by the frequency of messaging related to the recipient and sender, and displaying the sorted messages on a graphical user interface.

### BACKGROUND OF THE INVENTION

Conventionally, electronic messages such as text messages, instant messages, and/or email are sent and received between computers or handheld communication devices that allow the electronic messages (e.g., SMS messages) to be displayed separately and managed under different menus. For example, some conventional electronic messaging systems arrange messages in “sent” and “received” categories, and those messages in each category are arranged reverse-chronologically.

As the quantity of electronic messages increases, with this type of reverse-chronological system the user of such a system often must sort through a multitude of messages to locate those from a particular sender or group of senders that vary with time. As such, a mechanism for arranging electronic messages in a way that important messages are easily locatable, and which reflects changes in messaging habits over time, is desired.

### SUMMARY OF THE INVENTION

According to a first embodiment, an apparatus displays an arrangement of electronic data sorted by user preferences. The arrangement includes a plurality of electronic objects arranged in a plurality of rows on a graphical display. Each of the objects includes a sender field, a recipient field, a message field, and a time field. The plurality of rows are arranged in the graphical display such that each of the rows is associated with one of the electronic objects. At least one of the fields associated with each object is displayed in each row, and the rows are at least partially arranged by a frequency of communication between the sender and the recipient.

According to a second embodiment, a method of arranging electronic data includes receiving a plurality of message objects, sorting the message objects, and displaying the sorted message objects in a plurality of rows on a graphical display. The message objects each include a sender field, a recipient field, a message field, and a time field. Sorting of the message objects is at least partially by a frequency of communication between the sender associated and the recipient.

According to another embodiment, a system is capable of indicating object fields. The system includes a plurality of electronic objects. Each object comprises a sender field corresponding to a sender, a recipient field corresponding to a recipient, a message field, and a time field. A display is sortable by one or more of the fields. An indicator corresponding to the frequency of communication between the sender and the recipient is included in the display.

The above summary of various embodiments of the invention is not intended to describe each illustrated embodiment or every implementation of the invention. This summary represents a simplified overview of certain aspects of the invention to facilitate a basic understanding of the invention and is not intended to identify key or critical elements of the invention or delineate the scope of the invention.

### BRIEF DESCRIPTION OF THE DRAWINGS

FIG. 1 is a schematic illustration of a message object, according to an embodiment;

FIG. 2 is a flowchart illustrating a method of sorting and displaying message objects, according to an embodiment;

FIG. 3 is an example of a plurality of sorted rows illustrating sorting of different field types, according to an embodiment;

FIGS. 4A-4D are arrangements of rows of data sorted at least partially by a frequency of communication between the sender and the recipient, according to four embodiments;

FIG. 5 is a display of message objects including an indicator corresponding to the frequency of communication between the sender and the recipient, according to an embodiment;

FIGS. 6A-6D are displays of sorted message objects according to the user preferences of FIGS. 4A-4D, respectively.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE DRAWINGS

In the following detailed description of the present invention, numerous specific details are set forth in order to provide a thorough understanding of the present invention. However, one skilled in the art will recognize that the present invention may be practiced without these specific details. In other instances, well-known methods, procedures, and components have not been described in detail so as to not unnecessarily obscure aspects of the various embodiments of the present invention.

The systems and methods described with reference to the examples shown in the following figures enable a user to sort or view incoming messages in a number of ways. The user can change any of the sorting variables that define how the messages are displayed. For example, using this system, messages can be sorted and displayed by message frequency, groups, date received, whether a task is associated with the message, whether the message has been read, or the demographics of the sender, such as gender, location, or company, among others. Messages can be sorted and displayed after passing through multiple sorting filters, or filters that exclude certain messages. The frequency of messaging between the sender and recipient can be tracked or calculated. In some embodiments, this frequency can be shown graphically using an indicator such as color coding or a bar indicator. These features enable users to have more control of the way their electronic messages are displayed, sorted, and/or used.

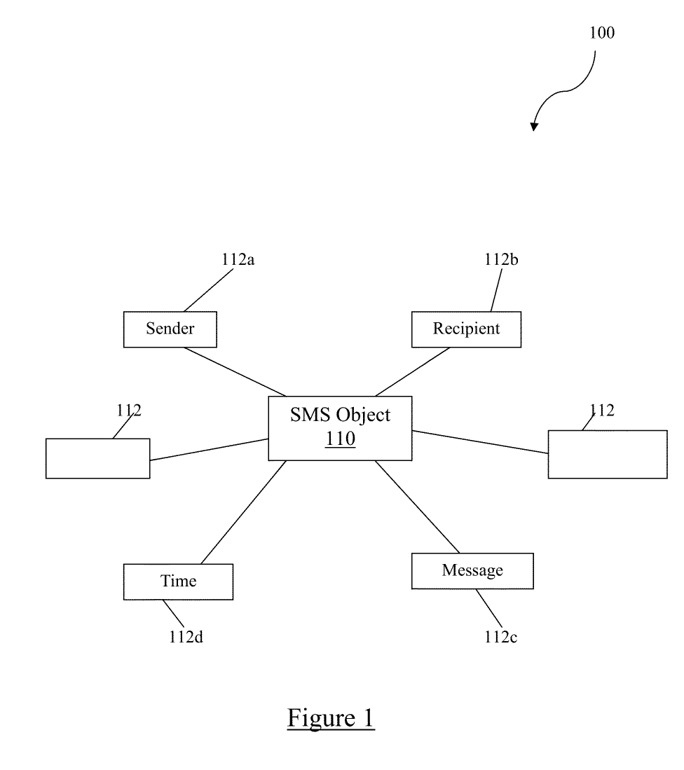

FIG. 1 is a schematic illustration of a message 100, according to an embodiment. Message 100 includes Short Message Service (SMS) object 110, which includes several fields 112. In alternative embodiments, message 100 could be an email or any other type of electronic message, such as, for example, an Enhanced Messaging Service (EMS) message, Multimedia Messaging Service (MMS) message, or Instant Message (IM).

SMS object 110 of FIG. 1 is a message object that is generated based on the receipt of an SMS message by a mobile phone or other computing device (not shown), according to one embodiment. Aspects of the present invention can be implemented as part of a computer system, referred to herein as a computing device, sending device, receiving device, or similar terms. The systems described herein can be one physical machine, or can be distributed among multiple physical machines, such as by role or function, or by process thread in the case of a cloud computing distributed model. In various embodiments, aspects of the invention can be configured to run in virtual machines (e.g., system virtual machines, operating system-level virtual machines, process virtual machines, or any combination thereof) that in turn are executed on one or more physical machines. It will be understood by persons of skill in the art that features of the invention may be realized by a variety of different suitable machine implementations, and that the specific computing device implementations described herein are for purposes of description only, and are not intended to be limiting.

For ease of description, SMS object 110 has been described as an object-oriented program element. In various embodiments, message data received by a phone or other computing device can be obtained in a variety of data structures, such as in arrays, packets, or concatenated strings, among others. SMS object 110 can be received in its entirety from a sending device, or it can be constructed by the receiving device, or some combination thereof.

In the embodiment shown in FIG. 1, fields 112 include a sender field 112a, recipient field 112b, message field 112c, and time field 112d. Additional unlabeled fields 112 are also shown. In various embodiments, unlabeled fields 112 could include an unread indicator field, a high/low priority field, a field corresponding to a group to which the sender belongs (such as coworkers, friends, or family), a field for an associated task request, and/or a field for a calendar entry, among others. Some of fields 112 can be received from the remote sending device, while other fields 112 can be generated or constructed by the receiving device itself So, for example, a field corresponding to a group to which the sender belongs may be stored on the receiving device, whereas message 112c is received from the sending device. In still further embodiments, some data (such as sender field 112a) can be provided by a third party such as a telecommunications network operator. In some cases, the receiving device can modify incoming data stored in fields 112. For example, sender field 112a can be modified in embodiments to include information stored in the receiving device about the sender. In some embodiments, sorting variables can be created from data gathered from one or more of the sender field, recipient field, message field, and time field.

The SMS object 110 described with respect to the embodiment shown in FIG. 1 can be sorted by any of the data found in its fields, by other data that are generated from a group of similar objects, by pre-defined variables, by user-created variables or by any combination of these data. Such sorting allows for users to have more control of the way their electronic messages are displayed.

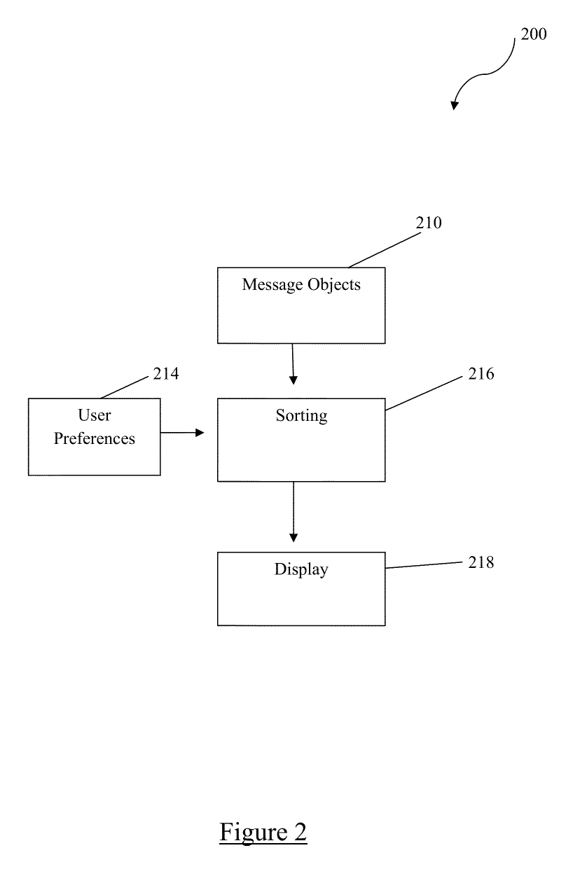

FIG. 2 is a flowchart illustrating a method 200 of sorting and displaying messages, according to an embodiment. Method 200 operates upon inputs including message objects 210 and user preferences 214. The message objects 210 undergo sorting 216 and are sent to a display 218.

Message objects 210 can include, for example, SMS object 110 of FIG. 1, or other objects or similar data structures corresponding to incoming text messages, instant messages, emails, and the like. As previously described with respect to FIG. 1, message objects 210 include fields relating to the incoming messages such as sender, recipient(s), timestamp, and message content. In some embodiments, message objects 210 can also include additional fields that are constructed as messages are received, such as information relating to the frequency with which messages are sent between the sender and recipient, or additional data on the sender that is stored by the recipient in a contacts list.

User preferences 214 can be used to sort message objects 210. User preferences 214 define categories and sub-categories into which message objects 210 can be sorted. As such, user preferences 214 can include one or more rules that relate to the handling, arrangement, sorting, or ordering of message objects 210. In some embodiments, user preferences can be created by the users such that one or more of the variables used to sort message objects is a user-defined and created variable.

At block 216, SMS objects 210 are sorted according to user preferences 214. As such, sorting 216 can act upon one or more message objects 210 to arrange, sort, or order the message objects 210 in a table, array, matrix, or similar data structure. Sorting 216 can be performed on a single field (e.g., message objects 210 can be sorted in reverse chronological order), or along multiple fields (e.g., message objects 210 can be sorted by user and by frequency of messaging between the sender and recipient).

According to some embodiments, frequency is used as a user preference for sorting SMS objects (e.g., SMS objects 210). Frequency can be determined based upon numerous criteria. For example, in some embodiments, frequency of messaging with a third party can be determined based upon the average time between sending of messages to that third party. In other embodiments, frequency of messaging with a third party can be determined based upon the average time between receiving messages from that party. In various alternative embodiments, the messages sent and received can be SMS messages, emails, IMs, MMS, and/or EHS messages, or any combination thereof. In various embodiments, frequency can be a function of both sent and received messages to and from the third party, only sent messages or only received messages. The exact formula by which frequency is calculated can be defined in numerous ways to enable those messages deemed important to a user to be seen efficiently. The amount of time over which frequency is determined can vary, either as a default setting or as set by a user. For example, frequency can be determined across the most recent week, month, year, etc. The types of messages used to determine frequency can also be varied. For example, only a particular type of message, i.e., SMS messages, may be used to determine frequency when that type of message is sorted. Alternatively, all message types, or a subset of message types, may be used in determining frequency even where only a single message type is being sorted.

In some embodiments, frequency can be dynamically updated. That is, the frequency associated with each message object 210 can be automatically be updated in real time as new messages are sent and/or received, and the relative positions of each message object 210 at sorting step 216 can change accordingly.

At block 218, the sorted message objects 210 from block 216 are sent to a display. The display can be a mobile phone screen, computer screen, or any other display on which the user can review the sorted message objects 210. Sorted message objects 210 can be arranged in the determined sort order, and can also include indicia as determined by user preferences 214. For example, color or symbol indicia can be added at display block 218 to identify messages having attachments, follow-up tasks, high or low relevance, or the frequency of communication between sender and recipient, for example.

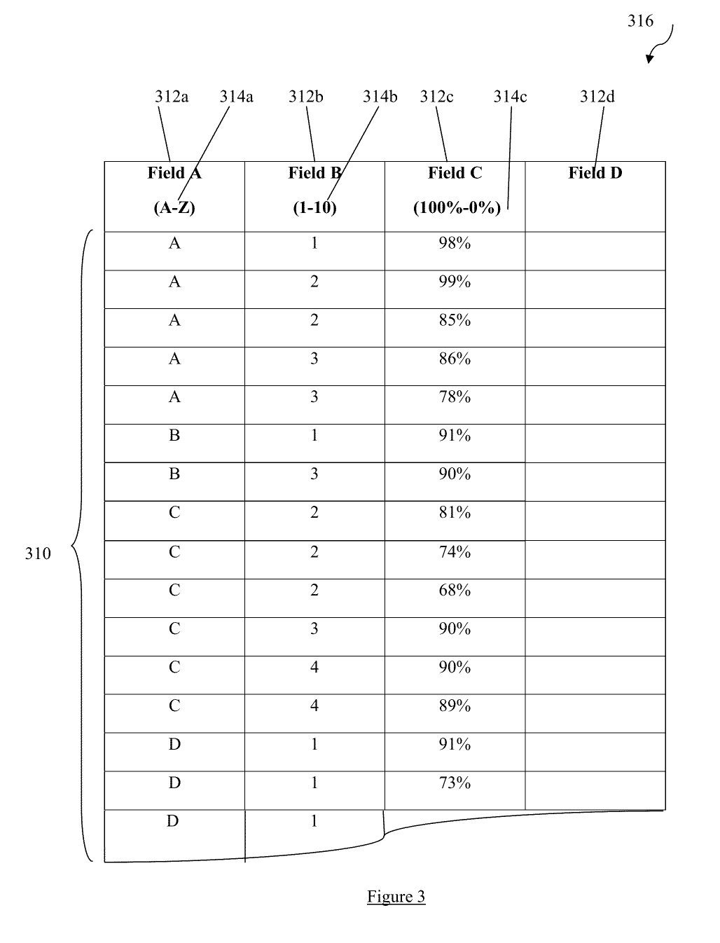

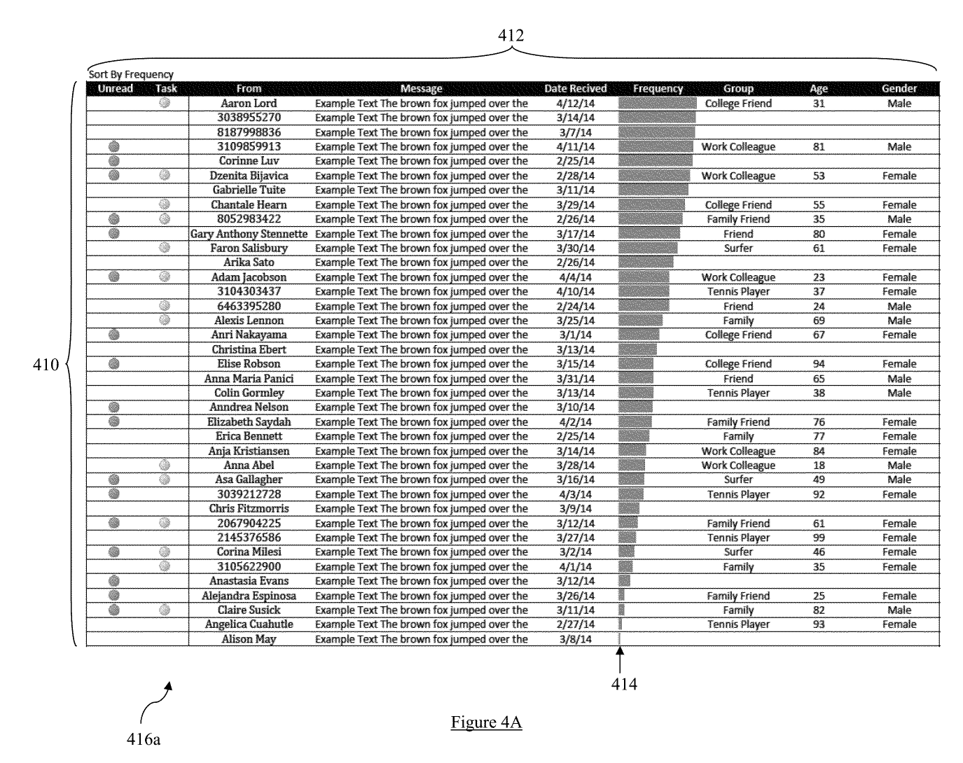

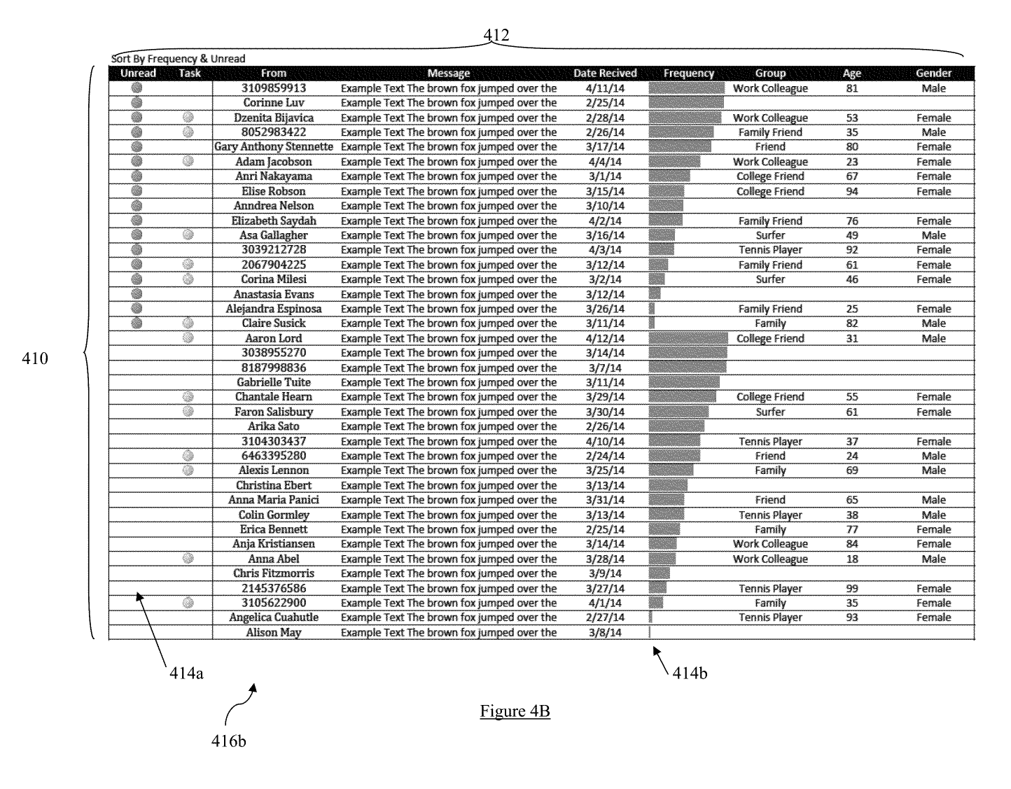

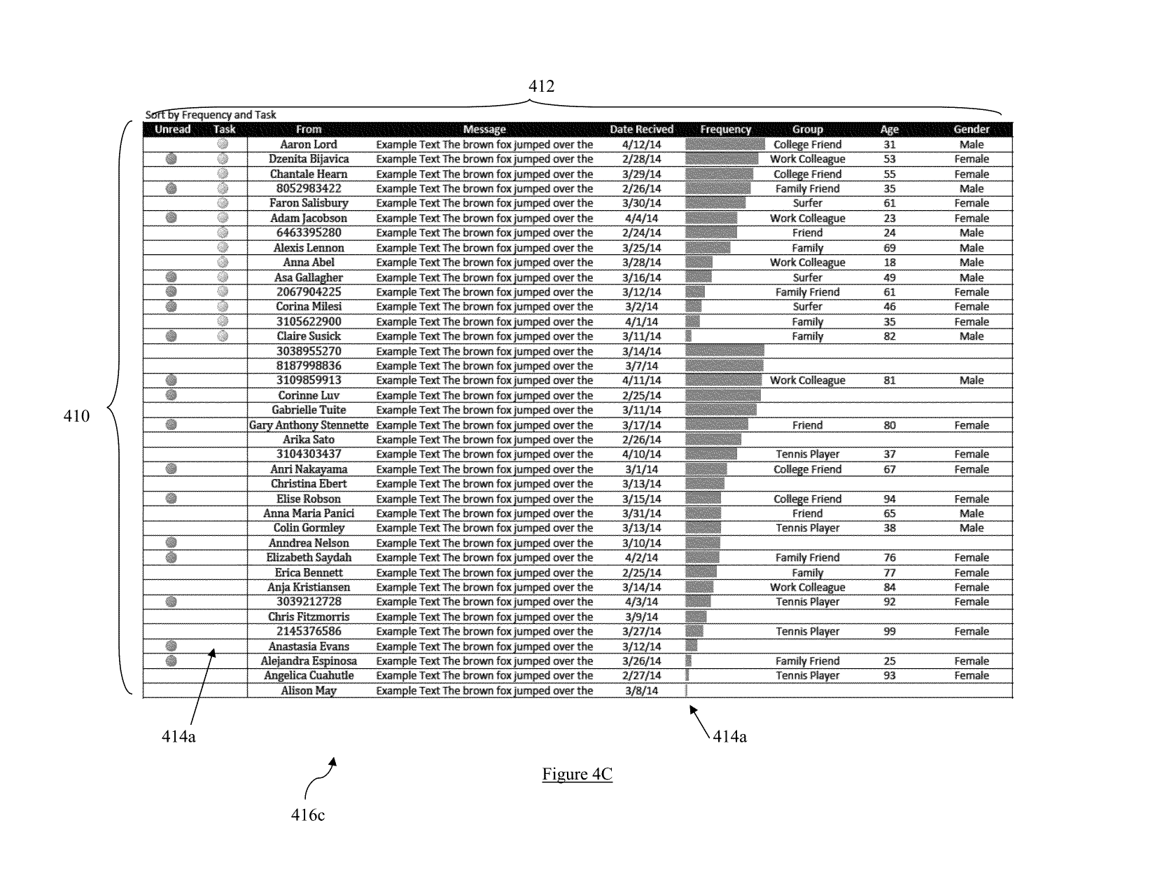

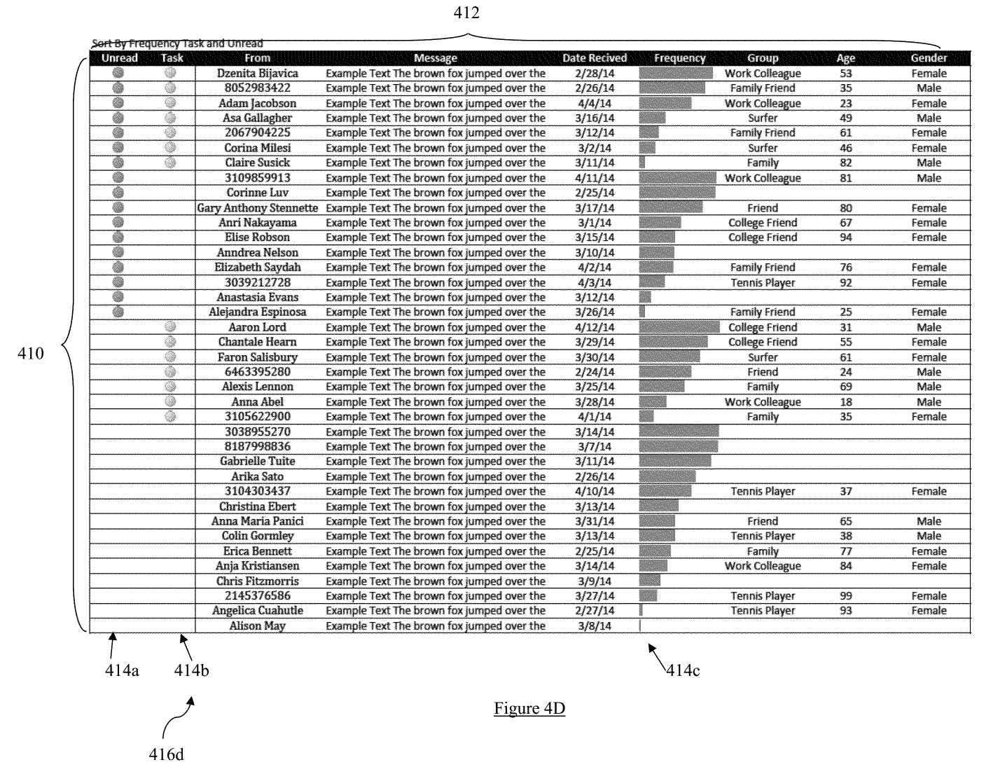

The results of one embodiment of a sorting block 216 are shown with respect to FIG. 3. Further illustrative results of sorting blocks 216, in which frequency of messaging between the sender and recipient is used as a sorting criterion, are shown with respect to FIGS. 4A-4D.

FIG. 3 illustrates sorted table 316. Sorted table 316 includes a plurality of rows, each corresponding to a single message object 310. Each message object 310 includes data corresponding to each of a series of fields 312a-312d. The message objects 310 are sorted according to user preferences 314a-314c.

The message objects 310 illustrated in FIG. 3 are for illustrative purposes only, and to that end have been simplified significantly. Fields 312 of message objects 310 include Field A (312a), a text field, Field B (312b), a numeric field, Field C (312c), a percentage, and Field D (312d), a message field.

In the embodiment shown in FIG. 3, three user preferences are defined: first user preference 314a, second user preference 314b, and third user preference 314c. Each user preference 314 can sort message objects 310 according to a criterion. For example, first user preference 314a sorts Field A (312a) alphabetically A-Z, second user preference 314b sorts Field B (312b) from 1 to 10, and third user preference 314c sorts Field C (312c) from 100% to 0%. As illustrated by these user preferences 314, various data types such as percentages, numbers, letters, and others can be sorted.

As shown in the example message objects 310, the primary sort occurs based on first user preference 314a. As such, all of the message objects 310 are sorted along Field A (312a). The secondary sort occurs based on second user preference 314b. Thus, message objects 310 having the same entry in field A (312a) are sorted by Field B (312b). Likewise, message objects 310 having the same entry in both field A (312a) and Field B (312b) are sorted by Field C (312c).

Not all fields of a given message object 310 must be sorted. For example, in the embodiment shown in FIG. 3, Field D (312d) is unsorted. User preferences 314 can include preferences on which data to sort, what order that data is sorted in, and what priority of sorting each field is given (i.e., which is the primary sorting field, secondary sorting field, tertiary sorting field, etc.).

FIGS. 4A-4D are arrangements of rows of data sorted at least partially by a frequency of communication between the sender and the recipient, according to four embodiments. FIG. 4A shows sorted object table 416a, which includes a plurality of message objects 410. Message objects 410 are separated into fields 412 including: Unread; Task; From; Message; Date Received; Frequency; Group; Age; and Gender.

Sorted object table 416a is sorted by user preferences. In the embodiment shown in FIG. 4A, sorted object table 416a has a primary sorting field 414 of Frequency. Frequency refers to the regularity with which the sender and recipient correspond with one another. Frequency could be defined as a function of the number of messages sent or received or both, phone calls made or received or both, or other data corresponding to the regularity of contact with the sender of each message object 410 as a function of time, or some combination thereof. No other fields are used for sorting in the embodiment shown in FIG. 4A. Frequency is shown as a bar in FIGS. 4A-4D, in which a larger bar refers to a higher frequency. In alternative embodiments, Frequency could be a scalar, a percentage, a frequency, a period, or any other indicator of frequency or relative frequency.

FIG. 4B includes the same example data (i.e., message objects 410) shown in the sorted object table 416a of FIG. 4A. Sorted object table 416b of FIG. 4B has two user preferences. In particular, sorted object table 416b has a primary sorting field 414a of Unread, and a secondary sorting field 414b of Frequency. As such, the first entries in sorted object table 416b are those which are unread, and among those message objects 410 the first entries are those in which Frequency is larger.

FIG. 4C includes the same example data shown in the sorted object tables 416a and 416b of FIGS. 4A and 4B, above. Sorted object table 416c of FIG. 4C has primary user preference 414a of Task, and secondary user preference 414b of Frequency. As such, the first entries in sorted object table 416c are those which are associated with a task for the recipient, and among those message objects 410 the first entries are those in which Frequency is larger.

FIG. 4D includes the same example data shown in the sorted object tables 416a-416c of FIGS. 4A-4C, above. Sorted object table 416d of FIG. 4D has primary user preference 414a of Unread, secondary user preference 414b of Task, and tertiary user preference 414c of Frequency. As such, the first entries in sorted object table 416d are those that are unread and are associated with a task. These message objects 410 are listed in descending order by Frequency. Next, unread message objects 410 without a task are shown, in decreasing order by frequency. Next, read message objects 410 with a task are shown, in decreasing order by frequency, and finally read message objects 410 without a task are shown in decreasing order by frequency.

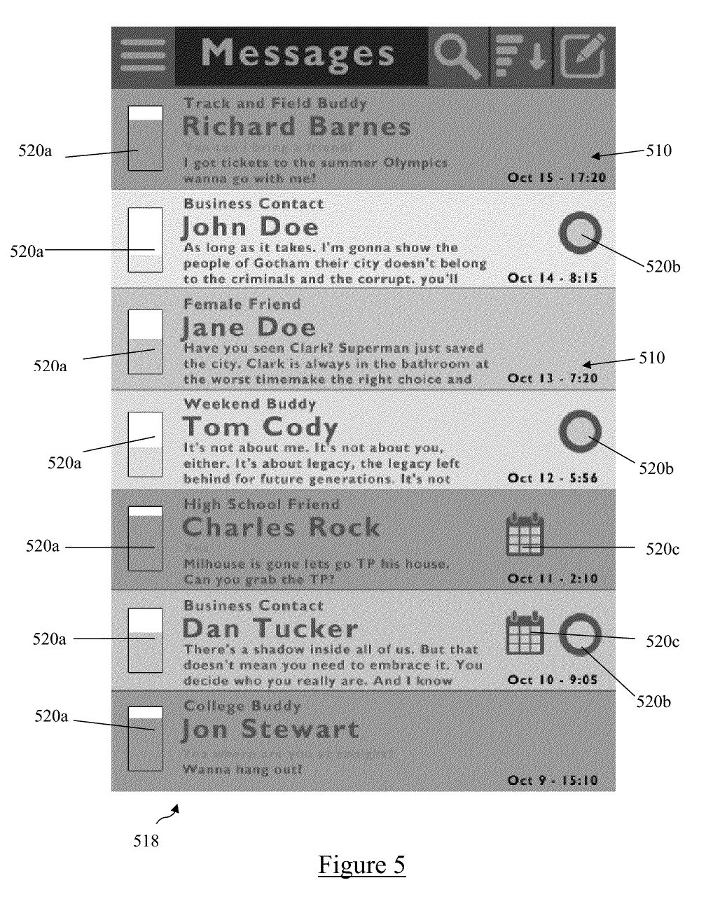

FIG. 5 illustrates one example of a display 518, which shows an arrangement of message objects 510 including indicators 520a-520c. In particular, individual message objects 510 can include a frequency indicator 520a, which indicates the relative frequency of communication between the particular sender and recipient of that message object 510. Display 518 also includes message objects 510 having unread indicators 520b, which identify those message objects 510 that have not been read. Furthermore, display 518 includes message objects 510 having task calendar indicators 520c, which identify those message objects 510 that include meeting or appointment requests. In one embodiment, display 518 can be the display of a device such as a mobile phone. In other embodiments, device can be, for example, a tablet computer, a desktop computer, a laptop computer, or any other computing device. The device can include a memory for storing messages, a communications port for receiving and sending messages and a processor for sorting and displaying messages on display as described herein. Alternatively, messages can be stored and/or sorted on a separate device and sent to the device for display.

In alternative embodiments, other indicators can be included in various message objects 510, for example, to indicate the priority of the message, to indicate a category (such as friends, coworkers, or family) in which the sender is a member, or any number of other fields by which the message objects 510 can be distinguished.

Notably, indicators 520a-520c can be, but need not be, used for sorting. For example, in the embodiment shown in FIG. 5, display 518 includes message objects 510 that are not sorted by frequency, yet frequency indicator 520a is included in the portion of display 518 corresponding to each message.

Furthermore, while indicators 520a-520c are graphical markers/images, in other embodiments indicators can be included that are not symbols but colors, patterns, fonts, or any other mechanism for distinguishing one message object 510 from another. For example, in the embodiment shown in FIG. 5, frequency is indicated not only by frequency indicator 520a, an emblem, but also by a different color/shading level covering the portion of display 518 corresponding to each message object 510.

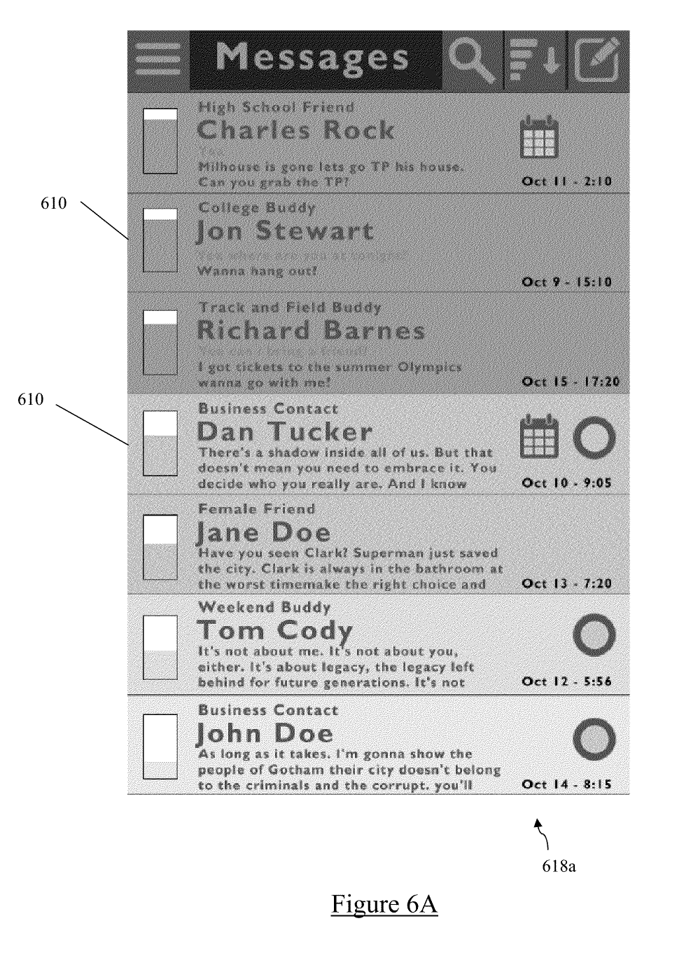

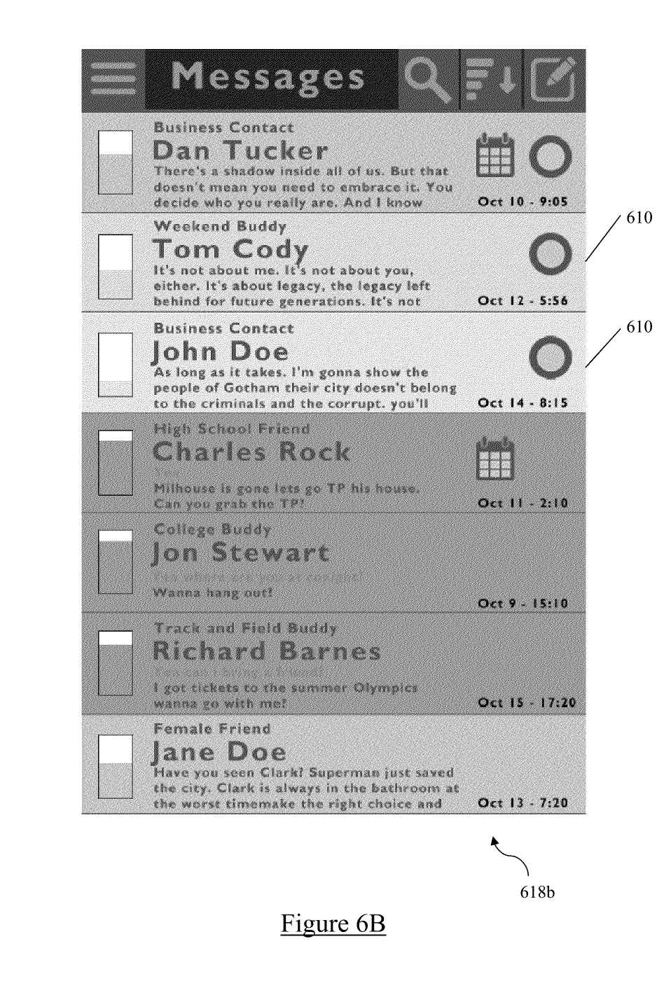

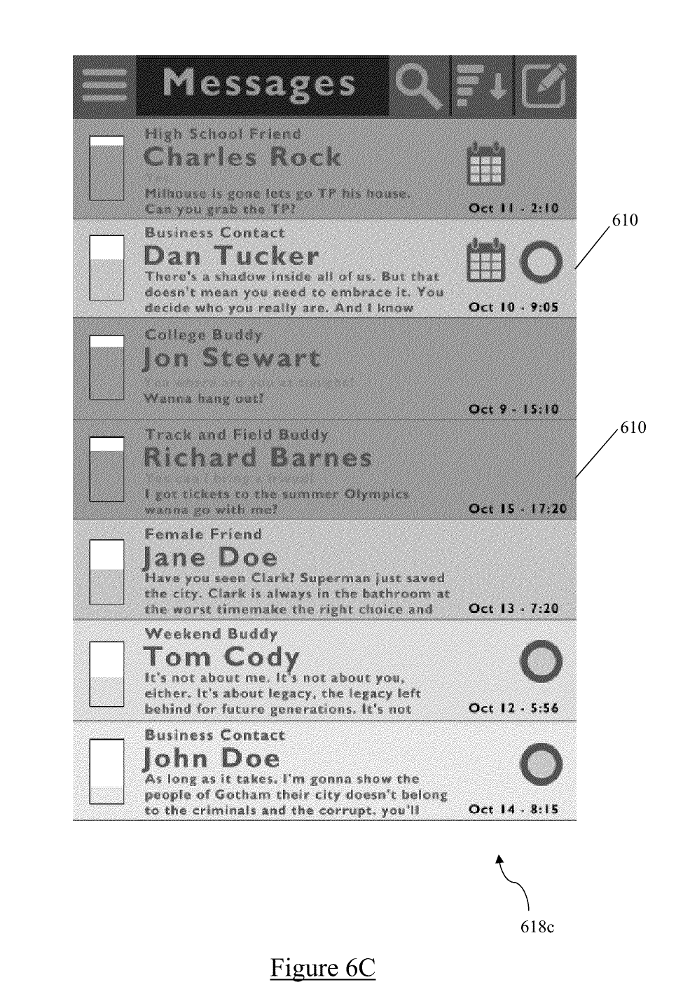

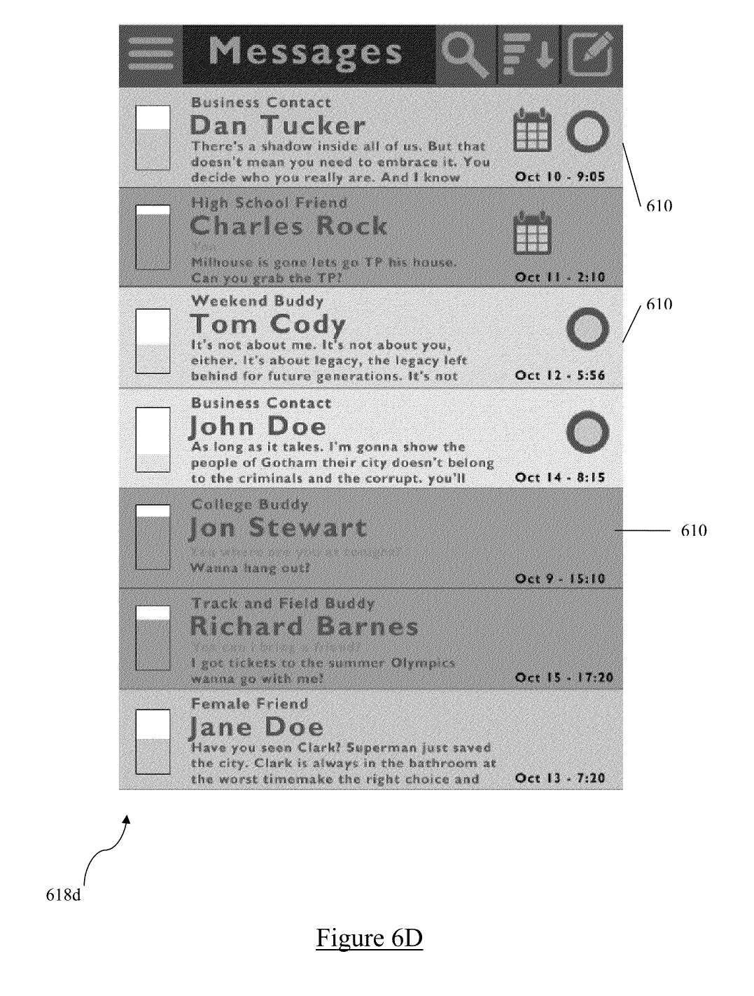

FIGS. 6A-6D are illustrations of displays of sorted message objects 610 that have been sorted according to user preferences of the embodiments shown in FIGS. 4A-4D, respectively. Each of FIGS. 6A-6D includes indicators as previously described with respect to FIG. 5, corresponding to frequency, tasks, and unread status. The displays shown in FIGS. 6A-6D can be, for example, a part of a mobile phone application (“app”). Such apps can draw message objects from one or more SMS inboxes and/or outboxes, email inboxes and/or outboxes, etc. In some embodiments, the app can sort each type of message separately and show them on displays such as those illustrated in FIGS. 6A-6D. In other embodiments, more than one of the various types of messages can be included on a single display.

FIG. 6A is a screenshot of display 618a generated based on user preferences similar to those shown with respect to sorted object table 416a of FIG. 4A. That is, message objects 610 are sorted in order of messaging frequency.

FIG. 6B is a screenshot of display 618b generated based on user preferences similar to those shown with respect to sorted object table 416b of FIG. 4B. That is, message objects 610 are sorted according to a primary user preference (unread status) and a secondary user preference (frequency).

FIG. 6C is a screenshot of display 618c generated based on user preferences similar to those shown with respect to sorted object table 416c of FIG. 4C. That is, message objects 610 are sorted according to a primary user preference (whether a task is associated with the message) and a secondary user preference (frequency).

FIG. 6D is a screenshot of display 618d generated based on user preferences similar to those shown with respect to sorted object table 416d of FIG. 4D. That is, message objects 610 are sorted according to a primary user preference (whether a task is associated with the message), a secondary user preference (unread status), and a tertiary user preference (frequency).

Various embodiments of systems, devices, and methods have been described herein. These embodiments are given only by way of example and are not intended to limit the scope of the present invention. It should be appreciated, moreover, that the various features of the embodiments that have been described may be combined in various ways to produce numerous additional embodiments. Moreover, while various methods, steps, data structures, dimensions, shapes, etc. have been described for use with disclosed embodiments, others besides those disclosed may be utilized without exceeding the scope of the invention.

1. An apparatus for displaying an arrangement of electronic data sorted by user preferences, the arrangement comprising:
a display;
a plurality of electronic objects, each of the plurality of electronic objects comprising:
a sender field corresponding to a sender;
a recipient field corresponding a recipient;
a message field; and
a time field; and
a plurality of rows arranged on the display, each of the rows associated with one of the electronic objects and displaying at least one of the fields associated with its associated electronic object, wherein the plurality of rows are at least partially arranged by a frequency of communication between the sender and the recipient.

2. The apparatus of claim 1, wherein the plurality of electronic objects comprises SMS messages.

3. The apparatus of claim 1, wherein the plurality of rows are arranged by a primary user preference according to which all of the rows are sorted and a secondary user preference that sorts the rows within the sort determined by the primary user preference.

4. The apparatus of claim 3, wherein the primary user preference and the secondary user preference are selected from the group consisting of:
messaging frequency;
task status;
unread status;
user-defined group;
age; and
gender.

5. The apparatus of claim 3, wherein the plurality of rows are further arranged by a tertiary user preference that sorts the rows within the sort determined by the primary user preference and the secondary user preference.

6. The apparatus of claim 1, wherein at least some of the plurality of rows of the display include an indicator.

7. The apparatus of claim 6, wherein the indicator represents the frequency of communication between the sender and the recipient.

8. The apparatus of claim 7, wherein the indicator is a background color corresponding to the frequency.

9. The apparatus of claim 7, wherein the indicator is a bar indicator.

10. A method of arranging electronic data, the method comprising:
receiving a plurality of message objects each comprising:
a sender field;
a recipient field;
a message field; and
a time field;
sorting the message objects at least partially by a frequency of communication between a sender associated with the sender field and a recipient associated with the recipient field; and
displaying the sorted message objects in a plurality of rows on a graphical display.

11. The method of claim 10, wherein the message objects comprise SMS messages.

12. The method of claim 10, wherein sorting the message objects further comprises at least partially sorting by a secondary user preference.

13. The method of claim 12, wherein sorting the message objects further comprises at least partially sorting by a tertiary user preference.

14. The method of claim 10, wherein displaying the sorted message objects includes displaying an indicator on each message object corresponding to the frequency.

15. A system for displaying and sorting electronic messages of a user, comprising:
a display;
a communications port adapted to send and receive electronic messages;
a memory adapted to store information relating to electronic messages; and
a processor communicatively coupled with the display, the communications port and the memory, wherein the processor is adapted to:
sort a plurality of electronic messages stored in the memory according to at least a frequency of communication between a sender of a message and a recipient of the message; and
display the electronic messages on the display according to the frequency.

16. The system of claim 15, wherein the processor is further adapted to dynamically update the sort and the display of the electronic messages in real-time as new messages are sent and received via the communications port.

17. The system of claim 15, wherein the frequency of communications between a sender of a message and a recipient of the message defines a first user preference according to which the plurality of electronic messages are sorted and the processor is further adapted to additionally sort the plurality of electronic messages according to a second user preference.

18. The system of claim 15, wherein the electronic messages are a first type of electronic messages and the frequency of communication between a sender of a message and a recipient of the message takes into account the first type of electronic message and additional types of electronic messages.

19. The system of claim 15, wherein the processor is further adapted to provide a visual indication of the frequency of communication between a sender of a message and a recipient of the message on the display adjacent the respective message.

20. The system of claim 19, wherein a type of visual indication is selected by the user from a plurality of types of visual indications.
